(19) United States
(12) Patent Application Publication
(10) Pub. No.: US 2003/0172229 A1
(43) Pub. Date: Sep. 11, 2003

(54) Systems and methods for detecting and compensating for runt block data transfers

(76) Inventors: Robin Alexis Takasugi, Eagle, ID (US); Stewart R. Wyatt, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/094,857

(22) Filed: Mar. 8, 2002

(51) Int. Cl. G06F 12/00

(52) U.S. Cl. 711/112; 711/154

(57) ABSTRACT

Systems and methods for detecting a runt block data transfer. A representative system includes a data transfer system having data organized into a plurality of sectors and a host device, a storage medium and a data transfer controller operably configured to couple between a host interface and a storage medium interface. The storage medium has stored thereon a plurality of sectors of data and the host having data organized into a plurality of blocks representing a multiple of sectors, the data transfer controller being configured to request a data transfer of a sector of data, conduct a first retrieval of sectors of data from the storage medium and decrement a counter containing the number of words for the current block size upon the first retrieval, conduct subsequent retrievals until either the counter value is zero or the counter value is less than a value in a register that contains the number of words for the current sector. An interrupt is triggered when the value of the counter is nonzero and less than the value in the register and the value in the counter is reset equal to the value in the register. The block of data remaining to be transferred is sent to the host. Systems and other methods also are provided.

### FIELD OF THE INVENTION

The present invention generally relates to data transfers in computer networks. More specifically, the invention relates to detecting runt block transfers in a non-volatile semiconductor memory controller.

### BACKGROUND OF THE INVENTION

Typically, non-volatile semiconductor memory devices store data in fundamental units of a certain size, e.g. 512 byte sectors. The memory device transfers those sectors to and from a host device by the memory device's controller according to a host interface protocol that organizes data into the same fundamental units. A single exchange of data units can occur in a data phase. The completion of a host device's request to transfer data may involve multiple data phases and requires actions to be performed by the controller's logic circuit or microprocessor intervention.

Host interface protocols define actions performed by the controller's logic circuit or microprocessor intervention. Some host interface protocols allow the exchange of data in a data phase in blocks which are multiples of data sectors. Hosts send data in blocks to reduce inter-sector overhead associated with handshaking each sector individually. When data is sent in multi-sector blocks, the handshaking occurs only at the end of the block. The actual transfer length requested of the storage device is, however, typically expressed in some host interface protocols in the fundamental data unit, e.g. 512-byte sectors. The host device requests the storage device to return data in data phases of multiple sectors. To complete the data transfer, at some point, the requested transfer may involve some number of data units which is not a multiple of the requested data phase size. If a data transfer system is configured to handle only multiples of the requested data unit, the data transfer may fail when the system encounters a phase size that is not a multiple of the requested data unit.

Based on the foregoing, it should be appreciated that there is a need for improved systems and methods that address these and/or other shortcomings of the prior art.

### SUMMARY OF THE INVENTION

The present invention relates to systems and methods for detecting runt block transfers in a non-volatile semiconductor memory controller. In this regard, a representative embodiment of one such method includes: requesting a data transfer from a source to a host, transferring the data from the source to the host, decrementing a counter in a controller upon each data transfer, continuing to transfer data until a value in the counter is nonzero but less than a value in a register that tracks the amount of data to be transferred in a data phase, and interrupting the controller when the value in the counter is nonzero and less than the value in the register and resetting the value in the counter equal to the value in the register.

A representative system for a runt block data transfer system includes a system that is configured to transfer data between a storage medium and a host system having data organized into a plurality of block sizes that may be a multiple of a data sector, and including a data transfer controller operably configured for coupling between the host system and the storage medium having stored thereon a plurality of data organized into data sectors. The data transfer controller is configured to request the storage medium to transfer at least one data sector, determine whether the number of data sectors requested is evenly divisible by a block size, and interrupt the data sector transfer request when the number of data sectors requested is not evenly divisible by the block size resulting in the occurrence of a runt block transfer. Upon interrupt, the data transfer controller resets the number of data sectors to be sent equal to the number of data sectors remaining to be transferred. The data transfer then occurs and the data transfer process is complete.

### BRIEF DESCRIPTION OF THE DRAWINGS

The present invention, as defined in the claims, can be better understood with reference to the following drawings. The drawings are not necessarily to scale, emphasis instead being placed on clearly illustrating the principles of the present invention.

FIG. 1 is a schematic diagram depicting an embodiment of a system that can be used to implement an embodiment of the runt block transfer system of the present invention.

FIG. 2 is a flowchart depicting functionality of an embodiment of a runt block transfer system of FIG. 1.

FIG. 3 is a schematic diagram depicting a computer or processor-based system that can be used to implement an embodiment of the runt block transfer system of the present invention.

FIG. 4 is a schematic diagram depicting an embodiment of the runt block system depicted in FIG. 1.

FIG. 5 is a schematic diagram depicting an embodiment of the host interface of the runt block system depicted in FIG. 4.

FIG. 6 is a schematic diagram depicting an embodiment of the data mover of the runt block system depicted in FIG. 4.

FIG. 7 is a schematic diagram depicting an embodiment of the storage medium interface of the runt block system depicted in FIG. 4.

FIG. 8 is a flowchart depicting functionality of an embodiment of a write transfer of the runt block transfer system of FIG. 1.

FIG. 9 is a flowchart depicting functionality of an embodiment of a read transfer of the runt block transfer system of FIG. 1.

### DETAILED DESCRIPTION

Disclosed herein is a memory device that provides a runt block transfer system. To facilitate description of the inventive system, an example device that can be used to implement the runt block transfer system is discussed with reference to the figures. Although this device is described in detail, it will be appreciated that this device is provided for purposes of illustration only and that various modifications are feasible without departing from the inventive concept. After the example device has been described, an example of operation of the device will be provided to explain the manner in which the device can be used to provide the runt block transfer.

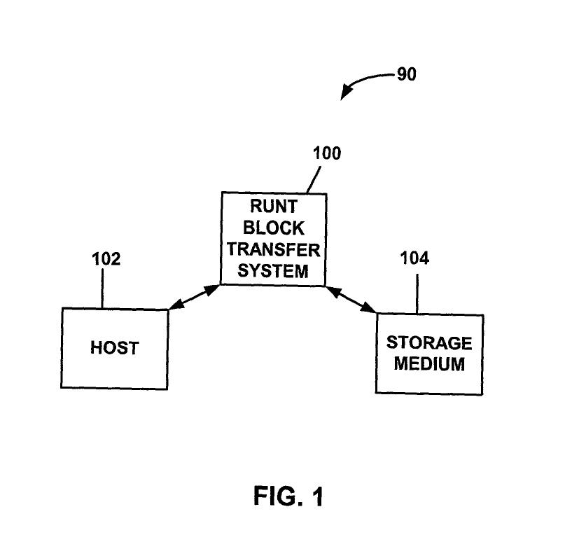

Referring now in more detail to the drawings, in which like numerals indicate corresponding parts throughout the several views, FIG. 1 is a schematic diagram depicting an embodiment of a system 90 that can be used to implement an embodiment of the runt block transfer system of the present invention. The system 90 includes a runt block transfer system 100 operatively coupled between a host device 102 and a storage medium 104. Transfers of data can occur between the host device 102 and the storage medium 104.

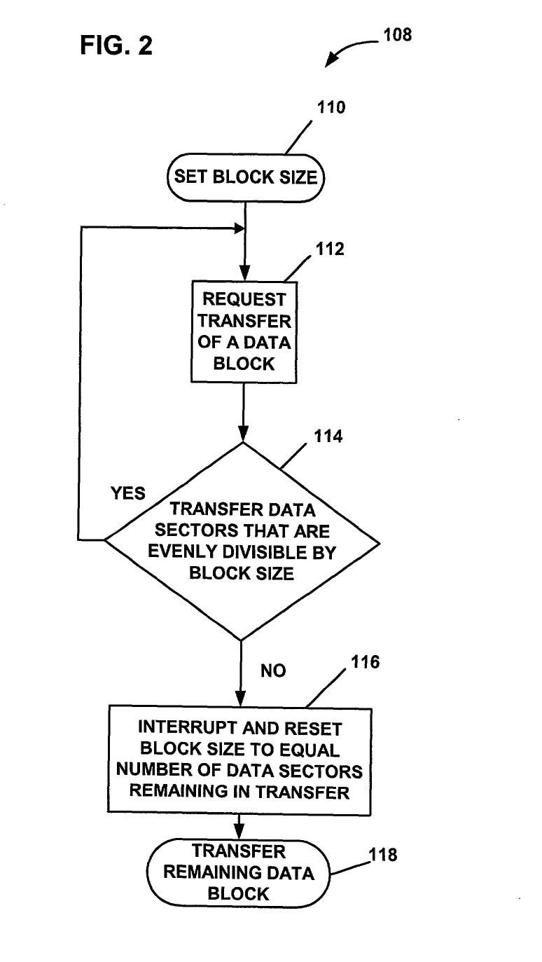

FIG. 2 is a flowchart 108 depicting functionality of an embodiment of a runt block transfer system of FIG. 1. Generally, at 110, the data block size is set to some number of sectors. At 112, a transfer of a data block is requested. Typically, the exchange of data is in data sectors grouped into blocks of one or more sectors. At 114, transfers of data blocks occur until the number of sectors remaining in the transfer is not evenly divisible by the block size set at step 110, and thus a “runt block transfer” condition occurs. When this condition occurs, at 116, the data transfers are interrupted and the block size is reset to equal the number of data sectors remaining in transfer so that the data sectors can be transferred. At 118, the remaining data sectors awaiting transfer are transferred and the data transfer is complete.

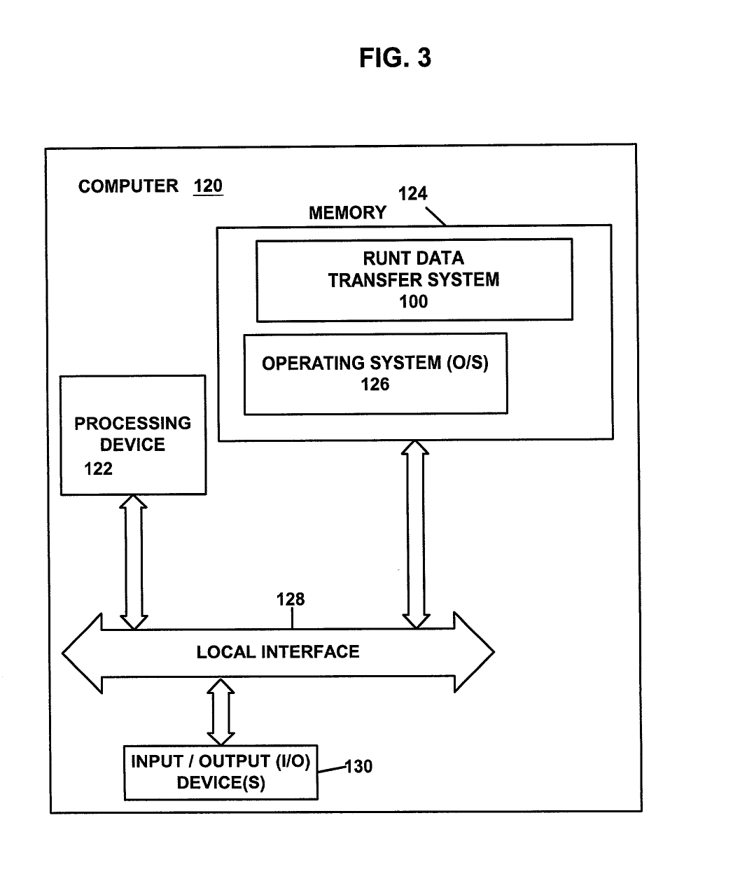

FIG. 3 illustrates a schematic diagram showing a computer or processor-based system that can be used to implement an embodiment of the runt transfer system. As will be described in greater detail below, a runt block transfer system can be used to transfer whole blocks of data in numerous data phases and can identify and transfer a data phase containing some sectors of data smaller than a whole block of data, referred to as a “runt block transfer.” Runt block transfer system can be implemented in software, firmware, hardware, or a combination thereof. When implemented in software, a runt block transfer system can be a program that is executable by a computer or processor-based device (“computer”) 120, an example of which is depicted schematically in FIG. 3.

Generally, in terms of hardware architecture, computer 120 of FIG. 3 includes a processor 122, memory 124, and one or more input and/or output (I/O) devices 130 (or peripherals) that are communicatively coupled via a local interface 128. Local interface 128 can be, for example, one or more buses or other wired or wireless connections, as is known in the art. Local interface 128 can include additional elements, which are omitted for ease of description. These additional elements can be controllers, buffers (caches), drivers, repeaters, and/or receivers, for example. Further, the local interface may include address, control, and/or data connections to enable appropriate communications among the components of computer 120.

Processor 122 can be a hardware device configured to execute software that can be stored in memory 124. Processor 122 can be any custom made or commercially available processor, a central processing unit (CPU) or an auxiliary processor among several processors. Additionally, the processor can be a semiconductor-based microprocessor (in the form of a microchip), for example.

Memory 124 can include any combination of volatile memory elements (e.g., random access memory (RAM, such as DRAM, SRAM, etc.)) and/or nonvolatile memory elements (e.g., ROM, hard drive, tape, CDROM, etc.). Moreover, memory 124 can incorporate electronic, magnetic, optical, and/or other types of storage media. Note that memory 124 can have a distributed architecture, where various components are situated remote from one another, but can be accessed by processor 122.

The software in memory 124 can include one or more separate programs, each of which comprises an ordered listing of executable instructions for implementing logical functions. The software in the memory 124 includes runt block transfer system software and a suitable operating system (O/S) 126. The operating system 126 controls the execution of other computer programs, such as runt block transfer system. Operating system 126 also can provide scheduling, input-output control, file and data management, memory management, and communication control and related services.

The I/O device(s) 130 can include input devices, such as a keypad and/or a receiver, for example. I/O device(s) 130 also can include output devices, such as a display device and/or a transmitter, for example. I/O device(s) 130 may further include devices that are configured to communicate both inputs and outputs, such as a network communication port, for example.

When the computer 120 is in operation, processor 122 is configured to execute software stored within the memory 124, communicate data to and from the memory 124, and generally control operations of the computer 120. Runt block transfer system 100 and the O/S 126, in whole or in part, are read by the processor 122, perhaps buffered within processor 122, and then executed.

When the runt block transfer system is implemented in software, it should be noted that runt block transfer commands can be stored on any computer-readable medium for use by or in connection with any computer-related system or method. In the context of this document, a computer-readable medium is an electronic, magnetic, optical, or other physical device or means that can contain or store a computer program for use by or in connection with a computer-related system or method. Runt block transfer system programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

As used herein, a “computer-readable medium” can be any means that can store, communicate, propagate or transport a program for use by or in connection with an instruction execution system, apparatus, or device. Thus, a computer readable medium can be, for example but not limited to, an electronic, magnetic, optical, electromagnetic, infrared, or semiconductor system, apparatus, device, or propagation medium. More specific examples (a nonexhaustive list) of a computer-readable medium include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program could be electronically captured, via optical scanning of the paper or other medium, then compiled, interpreted or otherwise processed in a suitable manner, if necessary, and then stored in a computer memory.

When implemented in hardware, the runt block transfer system can be implemented with any or a combination of various technologies. By way of example, the following technologies, which are each well known in the art, can be used: a discrete logic circuit(s) having logic gates for implementing logic functions upon data signals, an application specific integrated circuit (ASIC) having appropriate combinational logic gates, a programmable gate array(s) (PGA), and a field programmable gate array (FPGA).

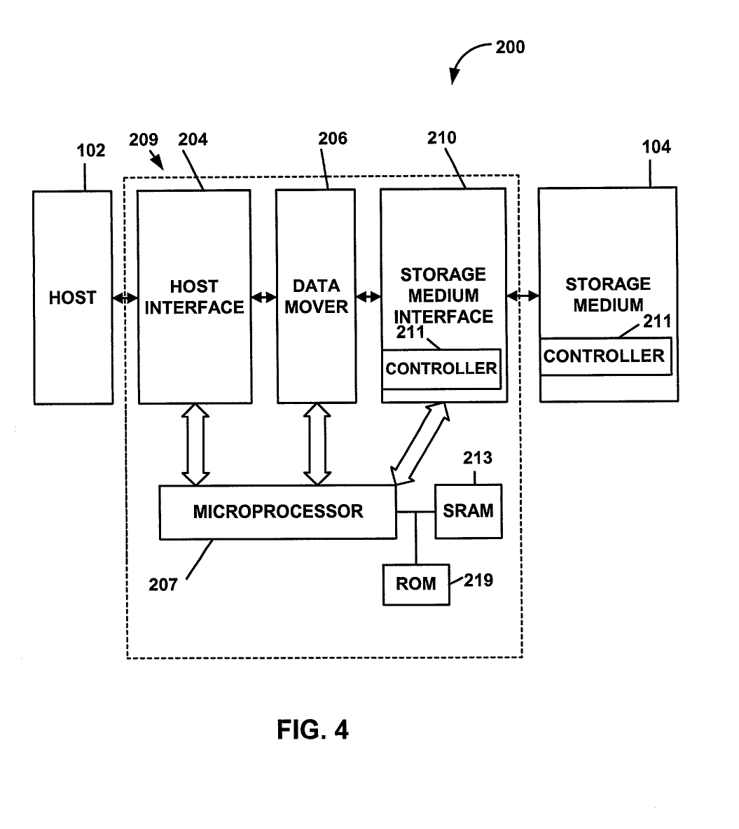

Reference is now be made to the schematic diagram of FIG. 4, which depicts the functionality of a representative embodiment of a runt block system 100 of the present invention. A system shown generally at 200 is configured to transfer data including runt block transfers in accordance with one embodiment of the invention. A host device 102 is coupled to a host interface 204. The host device 102 is generally an external device such as a computer having a processor and memory which is capable of running an application program that enables data to be read from and/or written to a data storage medium 104.

The host interface 204 couples to a data transfer processor, also referred to as a data mover or data transfer controller 206 for controlling the data transfers between the storage medium 104 and the host device 102. A storage medium interface 210 is coupled between the data storage medium 104 and the data mover 206. Storage medium 104 can be any means that can store, communicate, propagate, or transport a program for use by or in connection with an instruction execution system, apparatus, or device. A card, such as a memory interface card, has a number of registers including a multi-bit status register (not shown), of which two bits are of interest in this discussion. One bit represents a card device busy state (BUSY) and serves to lock out host access. Another bit represents a data request (DRQ) and serves to request a host data transfer.

The data mover 206 organizes and controls the flow of data between the host device 102 and the storage medium 104. Data mover 206 can include memory which enables data which is retrieved from the storage medium 104 to be temporarily stored until such time when it is appropriate to transfer the data to the host device 102.

In one embodiment, the host device 102 runs application programs that write command information to registers in the host interface 204. An operating system 126 handles host device communications by providing various services, such as making a collection of I/O commands available to application program, management of interrupt and DMA systems, and by providing a memory into which the data can be received. Data enters and leaves the host device 102 through the host interface 204 working under the control of the data mover 206.

As shown by phantom line, the host interface 204, data mover 206, a microprocessor 207, storage medium interface 210, memory, such as SRAM 213 and ROM 219, can be part of a single applications specific integrated circuit (ASIC) 209. In an alternative embodiment, the blocks shown in FIG. 4 may each reside on a separate ASIC or any combination of them may be integrated into a single ASIC.

Generally, in one embodiment, the host device 102 writes command information into registers which causes the hardware in the ASIC 209 to interrupt its embedded microprocessor 207. The microprocessor 207 is connected to the host interface 204, data mover 206, and storage medium interface 210 via buses that allow the microprocessor 207 to write and read registers in the host interface 204, data mover 206, and storage medium interface 210. The microprocessor 207 examines registers, extracts the command information, and sets up the hardware in the ASIC 209, i.e., the host interface 204, data mover 206, and storage medium interface 210, to perform the action requested in the command, for instance, read a sector of data. After the execution of the command, the microprocessor 207 stores status information for the operation in a register serving as a status register and may instruct the host 102 to read the status register. The firmware to run the host interface 204, data mover 206, and storage medium interface 210 may reside in a suitably sized SRAM 213 and/or ROM 219 at various addresses.

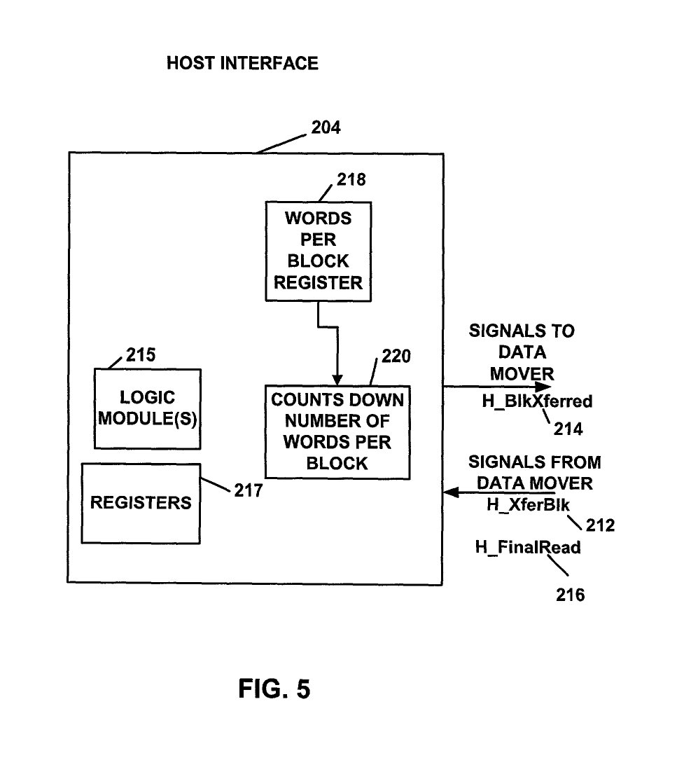

Referring to FIG. 5, a schematic diagram depicting an embodiment of the host interface 204 of the system 200 depicted in FIG. 4 is shown. The host interface 204 implements an interface with the host device 102 using industry standard protocols well known in the industry. In one embodiment, a suitable host interface is a CompactFlash™ type interface available from Hewlett-Packard Company. However, other memory technologies, including memories available from Hewlett-Packard Company, can be used in this invention.

The host interface 204 is coupled to both the host 102 and the data mover 206 and transfers blocks of data received from the data mover 206. In one embodiment, the firmware is controlled by a logic module(s) 215 of the host interface 204. The logic module(s) 215 of the host interface 204 includes code to operate a certain set of hardware, corresponding to the host interface and system infrastructure for instance, processor and its peripherals like timers, and a diagnostic port. The logic module 215 in the host interface 204 also contains code that allows access to host interface 204 registers and interrupt handlers.

As shown in FIG. 5, signals between the host interface 204 and the data mover 206 provide an indication of the status of each device and its readiness to continue a certain function. For instance, a H_XferBlk signal 212 from the data mover 206 indicates that the data mover 206 has a block of data to read or space for a write operation. The indication is asserted until cleared by a block transfer acknowledge (H_BlkXferred 214) signal. The H_BlkXferred signal 214 sent to the data mover 206 indicates that the host device 102 has completed the block transfer and may request the host interface 204 to continue with transfers of additional blocks of data. A H_FinalRead signal 216 sent from the data mover 206 indicates to the host interface 204 that the block the data mover 206 is about to send to the host interface 204, which is still sitting in the buffer, will be the last one in the transfer.

The host interface 204 includes a plurality of registers 217. Certain registers are internal to the host interface 204 and other registers are accessible by other system hardware components. Externally accessible registers include a words per block register 218 that is loaded as part of transfer initialization. During a runt block transfer, the words per block register 218 containing the value to be loaded into the words per block counter is reloaded with new words per block for final sector transfer. The re-loaded words per block size information is loaded from the externally accessible register 218 into the host interface 204 internal register 220 that counts words per block size. The block size may be but is not limited to the size that a buffer can hold. Although example registers have been described above, these examples of registers are not meant to be exhaustive but are instead merely representative of host interface registers.

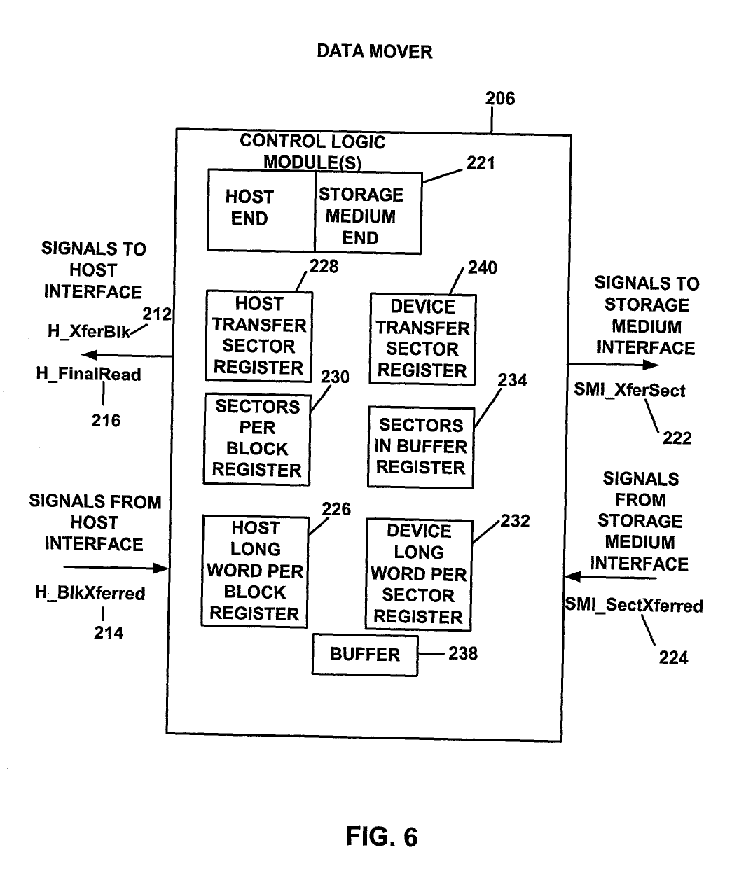

FIG. 6 shows a schematic diagram depicting an embodiment of the data mover 206 of the system 200 depicted in FIG. 4.

The data mover 206 communicates with the host interface 204 as described above. The data mover 206 is also in communication with the storage medium interface 210.

In one embodiment, a control logic module(s) 221 controls registers and a portion of the firmware that resides in a suitably sized SRAM 213 and/or ROM 219 at various addresses. The control logic module 221 contains code to operate a certain set of hardware usually corresponding to the host interface, device interface, system infrastructure, such as processor and its peripherals like timers, and a diagnostic port. The control logic module 221 contains control registers which control the operations the data mover 206 performs such as controlling the flow of data and whether data buffers can be written to or read from. The control logic module 221 also controls a soft reset function.

The control logic module 221 of the data mover 206 can be partitioned into two logical pieces, one for the host interface end and one for the storage medium interface end. The control logic module 221 generates interrupts, and interrupt controller firmware of the controller logic module 221 manages the interrupts. Signals serve to facilitate the data transfer between the storage medium interface 210 and the data mover 206. For instance, a SMI_XferSect signal 222 from the data mover 206 to the storage medium interface 210 indicates that the data mover 206 has a data sector to write or space for a read from the storage medium 104. A SMI_SectXferred signal 224 from the storage medium interface 210 indicates to the data mover 206 that the storage medium interface 210 has completed the current data sector transfer and requests to continue with transfer.

Registers reside internally in the data mover 206 and other blocks. Most are accessible to the microprocessor 207 and firmware; some are accessible only to the hardware, and some are accessible to both the microprocessor 207 and firmware and to the host device 102.

A HostXferSectCtr register 228 indicates the number of sectors to transfer defined by ATA Read Sectors, Write Sectors, Read Multiple Sectors or Write Multiple Sectors commands. In addition, a SectsPerBlk register 230 indicates the number of sectors in block as defined by ATA Set Multiple command. A HostDataOp register (not shown) is loaded with a particular host data transfer operation code (e.g., read or write).

On the storage medium end, a SMI_LW_PerSect register 232 indicates the long words per sector. A BuffSects register 234 indicates the number of sectors in a buffer 238 for access control. Buffers are included that hold sectors for transfer. The buffer can be for instance, a 1024-byte (2-sector) portion of SRAM 213. A data block is not limited to the size of the buffer and in some embodiments may be larger than the buffer size. A DeviceXferSectCtr register 240 indicates the number of sectors to be transferred. Interrupt registers (not shown) indicate an interrupt status from both the host end and/or the storage medium end of the data mover 206.

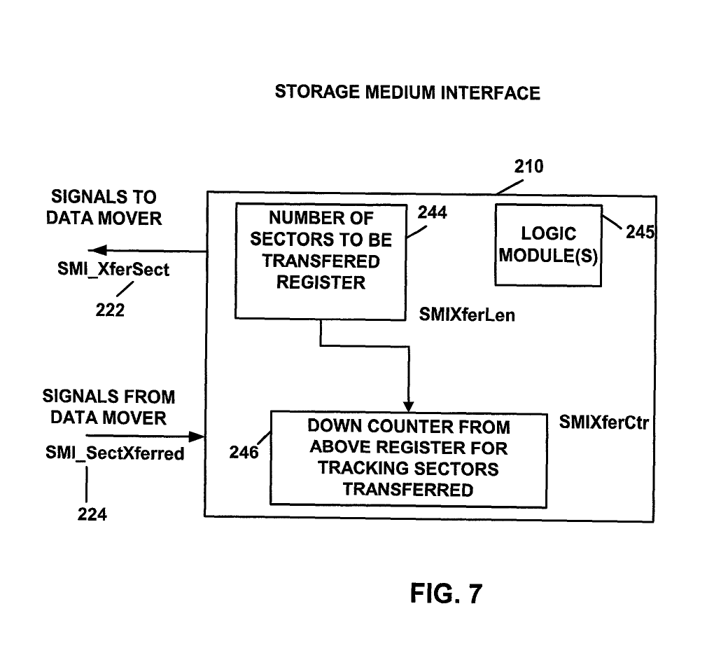

FIG. 7 shows a schematic diagram depicting an embodiment of the storage medium interface 210 (also referred to as a storage device interface) of the system 200 depicted in FIG. 4. The storage medium interface 210 includes registers, counters, and state machines to implement the protocol of writing commands to the storage device, transferring data and reading status. Facilities to write configuration information and read status from the storage device 104 and to execute the storage device reset protocol may reside in the storage medium interface 210. The storage medium interface 210 has circuitry to interface to the data mover 206 and the ability to control a number of external storage devices.

The storage medium interface includes a logic module(s) 245. The logic module 245 includes code that operates a certain set of hardware, usually corresponding to the device interface, system infrastructure for instance, processor and its peripherals like timers, and a diagnostic port. The logic module 245 in the storage medium interface 210 contains code and/or hardware to generate interrupts to the microprocessor 207 and the interrupt handlers. Firmware resides in a portion of SRAM 213 and/or ROM 219 of the ASIC 209.

The storage medium interface 210 signals to the data mover 206 as indicated above. Registers included in the storage medium interface 210 include a SMI_XferLen register 244 that indicates the number of data sectors to be transferred beginning at a proper transfer address. In addition, a SMIXferCtr register 246 serves as a down counter loaded from the SMI_XferLen register 244 for tracking data sectors transferred.

The examples of signals and registers are not meant to be exhaustive but merely representative of host interface, data mover and storage medium interface signals and registers.

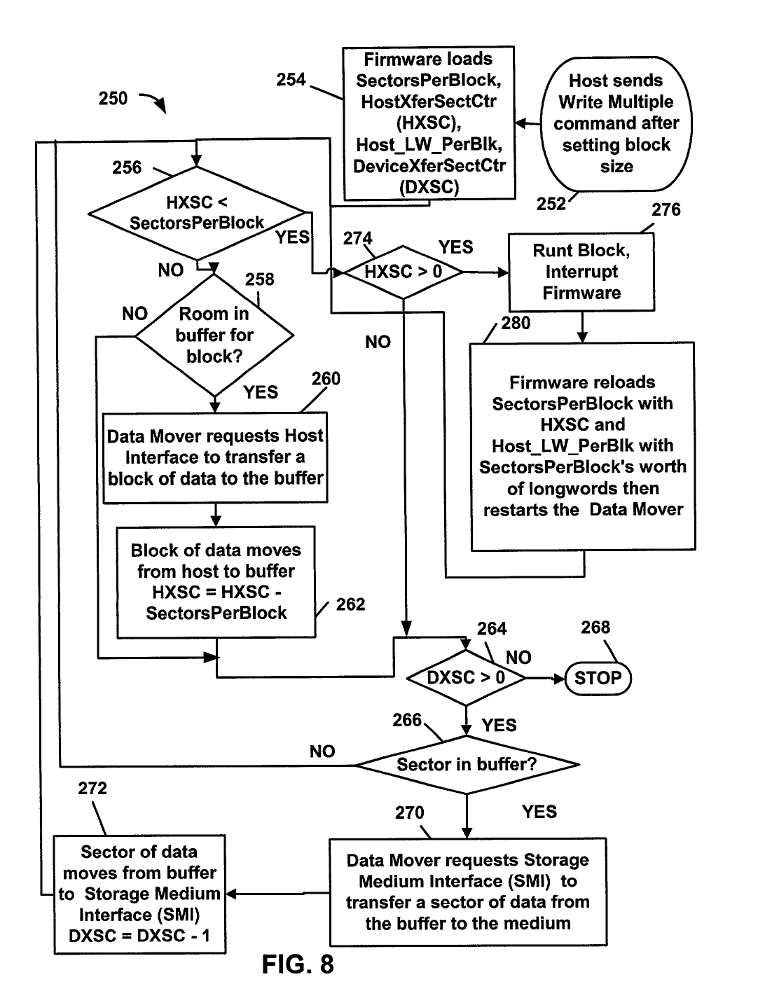

FIG. 8 shows a flowchart 250 depicting functionality of an embodiment of a write transfer of the system 200 of FIG. 4.

At 252, the host device sets the block size using a CompactFlash (hereinafter, “CF”) Set Multiple command. The host device requests data transfer via CF Read Sectors or Write Sectors command (target device uses block size of 1 sector/block) or via CF Read Multiple Sectors or Write Multiple Sectors command (target device uses the number of sectors per block previously specified in the Set Multiple command). The host device normally specifies the transfer length in sectors.

At 254, the firmware loads counters in the data mover with the transfer length in sectors using for instance, at the host interface end, HostXferSectCtr register and at the device interface end, DeviceXferSectCtr register. Firmware also loads a SectsPerBlk register (which works in concert with the HostXferSectCtr register) with the previously specified block size. The Host_LW_PerBlk register on the host interface side of the data mover is loaded with the number of internal data units, i.e., 32-bit longwords, per block. If the number of sectors in the transfer is evenly divisible by SectsPerBlk register, the firmware will not run again until the last data is transferred, and the events described below are all handled in hardware.

For a read or write operation, the data mover hardware will make a first request for a block of data from the host end for a write or for a sector from the device end for a read, by sending a signals H_XferBlk or SMI_XferSect, respectively. At this point a flowchart loop is in operation. In general terms, there is a “source end” and “destination end” of the data mover. In a read operation, the source end is the device interface portion of the data mover, and the destination end is the host interface portion. In a write operation, the source end is the host interface part and the destination end is the device interface part. Thus, the data mover hardware always starts the source end first and the destination end second.

For a write operation, as shown in FIG. 8, the source end is the host interface, so the data mover starts the source end by requesting the transfer of a block's worth of sectors. At 256, a comparison of the value of the HostXferSectCtr register is made to determine whether HostXferSectCtr register is less than SectsPerBlk register. If HostXferSectCtr is not less than SectsPerBlk register, HostXferSectCtr register is not exhausted and at 258 there is room in the buffer. The data mover hardware will then continue to request sectors from the host interface block. At 262, a block of data moves from the host to the buffer. The progress of transfers are tracked by managing the HostXferSectCtr register, which the data mover decrements by SectsPerBlk after each successful block transfer. At 264, if the DeviceXferSectCtr register is greater than zero then at 266, a check is performed to determine if sectors are remaining in the buffer. If the DeviceXferSectCtr register equals zero, the transfer is complete and at 268, the data mover stops requesting sectors from the device interface 210.

If sectors remain in the buffer, at 270, the data mover requests the device interface to transfer a sector of data from the buffer to the storage medium. At 272, a sector of data moves from the buffer to the device interface. The process continues at 256 to determine if the value of the HostXferSectCtr register is below the value in the SectsPerBlk register. At 274, the HostXferSectCtr register is below the value in the SectsPerBlk register, and a comparison of the HostXferSectCtr register is made to determine if it is nonzero. If the HostXferSectCtr register is nonzero and less than SectsPerBlk register, a runt block is awaiting transfer.

If the transfer length is not evenly divisible by SectsPerBlk register but HostXferSectCtr register is zero, i.e. no runt block exists, the process continues at 264. If the HostXferSectCtr register is nonzero and less than SectsPerBlk register a runt block condition exists and at 276, the data mover interrupts the firmware that the microprocessor is running in the SRAM or ROM. At that point, the code is waiting in a loop for the device end to finish, i.e., to reach 268. On a write or read, when all data is transferred to or from the host side, the host interface interrupts the microprocessor to inform it that the transfer is done on the host side and at the same time, the host interface is sending the H_BlkXferred signal to the data mover. On a Write command, the interrupt handler goes into a loop waiting for the device end to be completed. When the device end completes, the Write command is finished and the firmware can set up status and notify the host device to read it. For a read or write, status is sent when the destination end is done.

At 280, the firmware reprograms the SectsPerBlk register to the value in HostXferSectCtr register, and restarts the data mover. In an alternative embodiment, rather than creating an interrupt, failing the test at 256 with a nonzero value of HostXferSectCtr causes the SectsPerBlk register output to be deselected by use of a multiplexer and replaced by the output of HostXferSectCtr register. This configuration may require the addition of incremental hardware but increases the performance by avoiding the overhead of interrupt processing. The process starts at 256. To transfer all these remaining sectors to the buffer, the sectors will be requested from the host as a single, smaller-than-originally-specified, block. HostXferSectCtr register will finally become zero and the data transfer is finished on the host end; sectors then finish flowing from the buffer to the memory device. Upon servicing a runt block interrupt, the SectsPerBlk register is reloaded with the original number of sectors set by the host in the set multiple command.

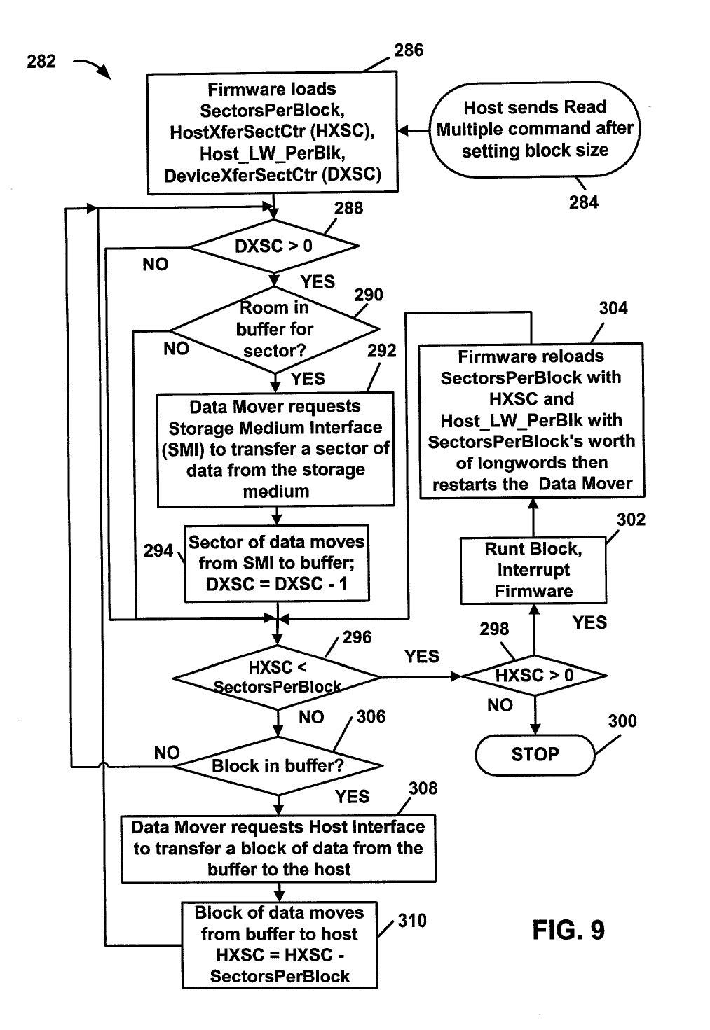

FIG. 9 is a flowchart 282 depicting functionality of an embodiment of a read transfer of the system 200 of FIG. 4. At 284, the host device sends a read multiple sectors command after setting the block size. At 286, the firmware loads SectsPerBlk register, HostXferSectCtr register, Host_LW_PerBlk register, and DeviceXferSectCtr register. At 288, a comparison is made to determine if the value of the DeviceXferSectCtr register is greater than zero. If yes, at 290, a determination is made if there is room in the buffer for a sector. If yes, at 292, the data mover requests the device interface to transfer a sector of data from the storage medium. At 294, a sector of data moves from the device interface to the buffer.

At 296, a comparison is made as to whether the HostXferSectCtr register is less than the SectsPerBlk register. If yes, at 298, a determination is made if the HostXferSectCtr register is greater than zero. If no, at 300, the data transfer process stops.

At 298, if the HostXferSectCtr register is greater than zero, at 302, a runt block transfer is required and the data mover interrupts the data transfer. In an alternative embodiment, rather than creating an interrupt, failing the test at 296 causes the SectsPerBlk register output to be deselected by use of a multiplexer and replaced by the output of HostXferSectCtr register. This configuration requires the addition of incremental hardware but increases the performance by avoiding the overhead of interrupt processing. At 304, firmware reloads SectsPerBlk register with HostXferSectCtr register value and Host_LW_PerBlk register with SectsPerBlk register worth of longwords and then restarts the data mover. The process continues at 296.

At 306, a determination is made as to whether a block is in the buffer. If no, the process continues at 288. If yes, at 308, the data mover requests the host interface to transfer a block of data from the buffer to the host. At 310, a block of data moves from the buffer to the host. The process continues at 288.

Block or sector handshaking occurs between the data mover and the interface blocks. The firmware has previously loaded registers on both host and device interface sides of the data mover with the number of internal data units (32-bit longwords) per block Host_LW_PerBlk register and per sector SMI_LW_PerSect register. Data mover hardware loads longword counters (for instance, Host_LW_Ctr and SMI_LW_Ctr) from these registers to tell the data mover when to expect an acknowledgment of the block or sector transferred by the host or device interface blocks. The host and device interface blocks themselves have internal block and sector longword counters to tell them when to acknowledge the transfer of the current sector or block.

Block or sector handshaking with the host interface or device interface blocks is performed as long as there are sectors left to be transferred; the data mover will request the transfer of a sector or block by sending the H_XferBlk signal to the host interface block or the SMI_XferSect signal to the device interface block. At this point the data flows between the buffer in the data mover block and the host interface or device interface blocks in units of longwords. In an alternative embodiment, counters in the host interface are 16 bits wide, e.g. half longwords. As each longword is transferred, data mover hardware decrements the Host_LW_Ctr or the SMI_LW_Ctr as the longword counters internal to the host interface and device interface blocks are decremented. At the end of a sector transfer with the device interface block, the device interface block's internal longword counter goes to zero, prompting it to send the sector acknowledgment SMI_SectXferred signal to the device interface end of the data mover, which is expecting this signal because its own SMI_LW_Ctr has gone to zero.

If there are more sectors to transfer, as indicated by a nonzero value in DeviceXferSectCtr, the data mover issues another SMI_XferSect signal to the device interface block and reloads the SMI_LW_Ctr.

Transfer of a block with the host interface end is performed similarly, with the data mover issuing a H_XferBlk signal. The host interface block's internal longword counter and the data mover's Host_LW_Ctr track the transfer of the longwords in a block. When the host interface block's internal longword counter goes to zero, it sends the H_BlkXferred signal to the data mover, which is expecting it since its own Host_LW_Ctr has gone to zero. Again, if there are more blocks to transfer, the longword counters are reloaded by the hardware and the data mover issues another Host_XferBlk signal.

An example of the present invention in operation is where the host sets a data phase size (i.e. a block) of four sectors. The host then sends a data transfer request with a length of eleven sectors. This transfer can not be completed in a number of integral data phases. The first transfer would send four sectors. Seven sectors remain to be sent. The next transfer would send four sectors. Three sectors remain to be sent. Thus, two whole block transfers were sent and a “runt block” data phase of three sectors remains to be sent. At this point the data transfer is interrupted and the data phase size is re-set to three sectors. The remaining three sectors to be sent now matches the data phase size (a block), and the transfer occurs. No additional sectors remain to be sent and the transfer completes. The processor or hardware then reloads the sectors per block register with a normal, non-runt value.

The foregoing description has been presented for purposes of illustration and description. It is not intended to be exhaustive or to limit the invention to the precise forms disclosed. Modifications or variations are possible in light of the above teachings. The embodiment or embodiments discussed, however, were chosen and described to provide the best illustration of the principles of the invention and its practical application to thereby enable one of ordinary skill in the art to utilize the invention in various embodiments and with various modifications as are suited to the particular use contemplated.

1. A data transfer system for transferring data between a storage medium and a host system, wherein the data is organized into a plurality of block sizes that may be a multiple of a data sector, the data transfer system comprising:
a data transfer controller operably configured for coupling between the host system and the storage medium, the data transfer controller having stored thereon a plurality of data organized into data sectors, wherein the data transfer controller is configured to:
request a host device to transfer at least one data sector;
determine whether the number of data sectors requested is evenly divisible by a block size; and
interrupt a data sector transfer request when the number of data sectors requested is not evenly divisible by the block size.

2. The data transfer system of claim 1, wherein the data transfer controller is further configured to reset the number of data sectors to be sent equal to the number of data sectors remaining in the transfer.

3. The data transfer system of claim 1, wherein the data transfer controller is further configured to request a transfer of the data sectors to the host device as long as the number of data sectors left to transfer is greater than or equal to the block size.

4. The data transfer system of claim 1, wherein the data transfer controller is further configured to request a transfer of the data sectors in the storage medium to the host device as long as the number of data sectors requested is greater than or equal to the block size and to reset the number of data sectors to be sent equal to the number of data sectors remaining in the transfer before transferring the data sectors from the storage medium to the host device.

5. The data transfer system of claim 1, further comprising a storage medium interface operably configured to couple the storage medium to the data transfer controller and a host interface operably configured to couple the host device to the data transfer controller.

6. The data transfer system of claim 1, further comprising registers that counts the number of data sectors remaining in the transfer.

7. The data transfer system of claim 1, wherein the data transfer controller further comprises a buffer that contains the data sectors waiting to be sent.

8. The data transfer system of claim 5, wherein the data transfer controller is configured to request the storage medium interface to transfer data sectors from the storage medium to the data transfer controller.

9. The data transfer system of claim 5, wherein the storage medium interface is configured to acknowledge to the data transfer controller that a sector of data has been transferred to the storage medium.

10. The data transfer system of claim 5, wherein the host interface acknowledges to the data transfer controller that a block of data has been transferred to host.

11. The data transfer system of claim 1, wherein the data transfer controller further comprises registers that decrement by the number of data sectors transferred to host device.

12. The data transfer system of claim 8, wherein the storage medium interface is configured to transfer the sectors of data move from the storage medium to a buffer in the data transfer controller.

13. The data transfer system of claim 12, further comprising a comparator that compares the number of sectors of data in the buffer to the number of sectors in a host transfer register.

14. The data transfer system of claim of claim 8, wherein the data transfer controller is configured to determine whether a block of data resides in a buffer in the data transfer controller.

15. The data transfer system of claim of claim 14, wherein the data transfer controller is configured to request the host interface to transfer the block of data from the buffer to the host system and the block of data transfers from the buffer to the host system.

16. The data transfer system of claim of claim 5, wherein the data transfer controller is configured to request that a block of data be transferred into a buffer when the buffer has memory available to store the block of data.

17. The data transfer system of claim 16, wherein the data transfer controller moves the block of data from the host system to the buffer in the data transfer controller.

18. The data transfer system of claim 17, further comprising a comparator that determines if a value in a sector transfer counter in the data transfer controller is greater than zero and if not stops the data transfer.

19. The data transfer system of claim 18, wherein if the value in the sector transfer counter is greater than zero, the data transfer controller is configured to determine whether a sector of data is in a sector buffer.

20. The data transfer system of claim 19, wherein if the sector of data resides in the sector buffer, the data transfer controller is configured to request the storage interface medium to transfer the sector of data from the sector buffer to the storage medium.

21. The data transfer system of claim 20, wherein the data transfer controller is configured to transfer the sector of data to the storage medium.

22. A method for detecting a runt block transfer in a data transfer processing system, comprising:
requesting a data transfer from a source to a host;
transferring the data from the source to the host and decrementing a counter in a controller upon each data transfer; and
continuing to transfer data until a value in the counter is nonzero but less than a value in a register that tracks the amount of data to be transferred in a single data phase.

23. The method of claim 22, further comprising interrupting the controller when the value in the counter is nonzero and less than the value in the register and resetting the value in the counter equal to the value in the register.

24. The method of claim 22, further comprising replacing the value in register with the value in the counter.

25. The method of claim 22, further comprising deselecting the value in the register using a multiplexer and replacing the value in the register with the value in the counter.

26. The method of claim 22, further comprising loading the register with a number of sectors in a block and loading the counter with a number of sectors to be transferred.

27. The method of claim 26, further comprising setting a block size as a multiple of a sector.

28. The method of claim 26, wherein the step of requesting a data transfer from a source to a host further comprises requesting the data transfer of a block of data by sending a signal to a host interface.

29. The method of claim 22, wherein the step of requesting a data transfer from a source to a host further comprises requesting a transfer of a sector of data by sending a signal to a storage medium interface.

30. The method of claim 29, further comprising storing the block of data in a buffer.

31. The method of claim 30, further comprising storing the sector of data in a buffer.

32. The method of claim 22, further comprising defining the data as sectors and sending data to the host as a single block when the sectors of that single block are in a buffer.

33. The method of claim 32, further comprising decrementing the counter and discontinuing the requesting of data transfers when the sectors fill the buffer.

34. A data transfer processor stored on a computer-readable medium, the data transfer processor being executable by a controller, comprising:
logic configured to request a storage medium to transfer at least one data sector of a plurality of data sectors remaining in a request;
logic configured to determine whether sectors remaining in the request are evenly divisible by a defined block size; and
logic configured to interrupt a data sector transfer request when a number of data sectors requested is not evenly divisible by the block size.

35. The data transfer processor of claim 34, further comprising logic configured to reset the number of data sectors to be sent equal to the number of data sectors left to be transferred.

36. The data transfer processor of claim 34, further comprising logic configured to transfer the data sectors in the storage medium to the host device as long as the number of data sectors left to transfer is evenly divisible by the block size.

37. A system for detecting runt block transfers, comprising:
a host device for setting a size of data blocks;
a storage medium for storing data in data sectors; and
a runt block transfer system operatively coupled between the host device and the storage medium, the runt block system adapted to transfer data sectors between the host device and the storage medium while the data sectors are evenly divisible by block size.

38. The system of claim 37, wherein the runt block transfer system further comprises logic configured to interrupt the data transfers when the data sectors left to transfer are not evenly divisible by block size.

39. The system of claim 38, wherein the runt block transfer system further comprises logic configured to reset block size equal to number of data sectors remaining in transfer and to transfer remaining data sectors.

40. A system for detecting runt block transfers, comprising:
means for setting a size of data blocks;
means for storing data in data sectors; and
means that couples the means for setting the size of data blocks to the means for storing data in data sectors, the means adapted to transfer data sectors between the means for setting the size of data blocks and the means for storing data in data sectors while the data sectors are evenly divisible by the block size.

41. The system of claim 40, wherein the means that couples the means for setting the size of data blocks to the means for storing the data in data sectors further comprises logic configured to interrupt the data transfers when the data sectors left to transfer are not evenly divisible by block size.

42. The system of claim 41, wherein the means that couples the means for setting the size of data blocks to the means for storing the data in data sectors further comprises logic configured to reset block size equal to the number of data sectors remaining in transfer and to transfer remaining data sectors.
